(19) United States
(12) Patent Application Publication
(10) Pub. No.: US 2006/0123775 A1
(43) Pub. Date: Jun. 15, 2006

(54) Turbocharger-catalytic converter assembly

(75) Inventors: Dirk Ellenberger, Enkenbach-Alsenborn (DE); Marco Kuschel, Kirchheimbolanden (DE)

Correspondence Address: BorgWarner Inc.;Patent Docket Administrator, 3850 Hamlin Road, Auburn Hills, MI, 48326, US

(73) Assignee: BorgWarner Inc., Auburn Hills, MI (US)

(21) Appl. No.: 11/300,221

(22) Filed: Dec. 14, 2005

(30) Foreign Application Priority Data
Dec. 14, 2004 (EP) 04029587.5

(51) Int. Cl. F01N 7/10; F02B 33/44

(52) U.S. Cl. 60/323; 60/598; 60/322; 60/299; 29/890

(57) ABSTRACT

The present invention refers to a turbocharger-catalytic converter assembly comprising a turbine casing of the turbocharger which includes a turbine casing flange; a catalyst flange as part of the catalytic converter; and a connecting means which fixes the turbine casing flange and the catalyst flange to each other with interposition of a seal, wherein an insulation layer of a thermally resistant elastic material is arranged between the connecting means and the turbine casing flange and the catalyst flange.

### CROSS-REFERENCE TO RELATED APPLICATIONS

This application claims priority to European Patent Application No. 04029587.5 filed Dec. 14, 2004.

### FIELD OF THE INVENTION

The present invention relates to a turbocharger-catalytic converter assembly.

### BACKGROUND OF THE INVENTION

An example illustrating a combination between a turbocharger and one or several catalytic converters is given in DE 699 13 149 T2. Whenever the turbocharger is connected to the catalytic converter in such an assembly, said connection is established via a catalyst flange and a turbine casing flange with the help of an appropriate connecting means. A sealing means is interposed between the flanges.

In such an assembly, however, problems arise with respect to an undesired high acoustic pressure level in the interior of the vehicle, which is due to the transmission of vibrations between the catalyst flange and the turbine casing flange.

It is therefore the object of the present invention to provide a turbocharger/catalytic converter assembly with which it is possible to reduce the acoustic pressure level in the interior of the vehicle to a considerable extent.

### SUMMARY OF THE INVENTION

Thanks to the use of a thermally resistant elastic material between the flanges of the turbine casing and the catalytic converter and of the connecting means which fixes the flanges, it is possible according to the invention to reduce the transmission of vibrations between the exhaust gas turbocharger and the catalytic converter to a considerable extent.

Investigations conducted within the scope of the invention have shown that the acoustic pressure level in the interior of the vehicle can be reduced by this measure by at least 6 dB.

The subclaims refer to advantageous developments of the invention.

Further details, advantages and features of the present invention become apparent from the following description of the invention with reference to the attached drawing, in which:

### BRIEF DESCRIPTION OF THE DRAWINGS

FIG. 1 is a schematically simplified view of a first embodiment of a turbocharger/catalytic converter assembly;

FIG. 2 is a view corresponding to FIG. 1, which shows a second embodiment of the turbocharger/catalytic converter assembly according to the invention; and

FIG. 3 is a schematically simplified view of a divided insulation layer in which the plane of division is positioned radially over the circumference of the insulation layer.

### DETAILED DESCRIPTION OF THE PREFERRED EMBODIMENTS

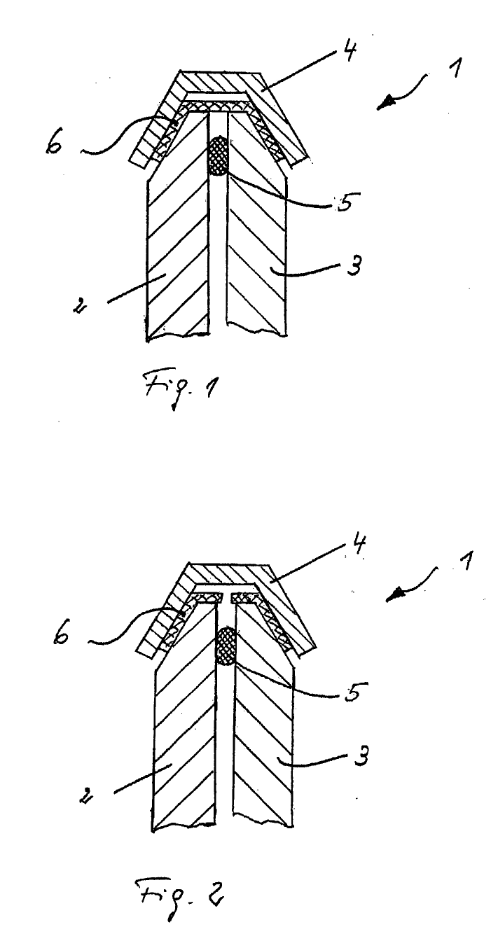

FIG. 1 is a schematically simplified view of a turbocharger/catalytic converter assembly 1. Said assembly 1 comprises a turbine casing flange 2 which is part of the turbine casing of the turbocharger, which is not shown in more detail in the figure. It goes without saying that said turbocharger comprises all of the other standard components, such as turbine, compressor impeller, associated casing and bearing housing with the bearing assembly for supporting the shaft of the turbocharger.

The catalytic converter in its entirety is also not shown in more detail in the figure, but is just represented by a catalyst flange 3. A seal 5 is arranged between the turbine casing flange 2 and the catalyst flange 3.

According to the invention, an insulation layer 6 of a thermally resistant elastic material is also provided. FIG. 1 illustrates that the insulation layer 6 together with the connecting means 4, preferably in the form of a clip, permits the fixation of the two flanges 2 and 3 to each other with interposition of the insulation layer 6.

The insulation layer 6 is here arranged such that it bridges the distance between the flanges 2 and 3 and is arranged between the connecting means 4 and the flanges 2 and 3.

The insulation layer 6 consists, for example, of a dimensionally unstable tissue-like material which is inserted between the connecting means 4 and the contact surfaces of the two flanges of turbine casing and catalytic converter.

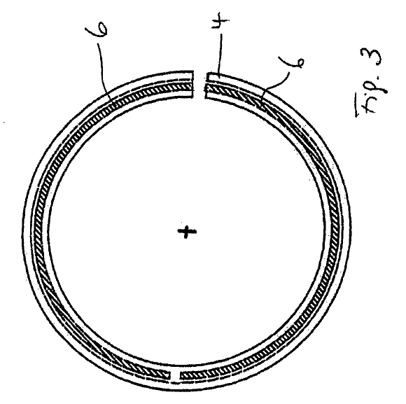

The material of the insulation layer 6, however, may also be pre-shaped, i.e. in a manner that it imitates the outer shape of the two flanges 2 and 3 as exactly as possible. A division of the insulation layer 6 is even possible. The plane of division may here be positioned centrally, either axially between the flanges 2 and 3 (FIG. 2) or radially over the circumference thereof (FIG. 3).

Preferably, the material for the insulation layer 6 may be a high-temperature insulation material which is obtainable under the name “ZETEX”.

Since the other parts of the catalytic converter are also not needed for explaining the principles of the present invention, these are not shown in the figure.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A turbocharger-catalytic converter assembly comprising:
a turbine casing of the turbocharger which includes a turbine casing flange;
a catalyst flange as part of the catalytic converter; and
a connecting means which fixes the turbine casing flange and the catalyst flange to each other with interposition of a seal, wherein an insulation layer of a thermally resistant elastic material is arranged between the connecting means and the turbine casing flange and the catalyst flange.

2. The turbocharger/catalytic converter assembly according to claim 1, wherein the insulation layer interrupts the metallic contact between the turbine casing flange and the catalyst flange through the connecting means.

3. The turbocharger/catalytic converter assembly according to claim 2, wherein the insulation layer has a pre-shaped form of the flange connection.

4. The turbocharger/catalytic converter assembly according to claim 1, wherein the material of the insulation layer is a high-temperature insulation material.

5. The turbocharger/catalytic converter assembly according to claim 1, wherein the connecting means is configured as a clip.

6. The turbocharger/catalytic converter assembly according to claim 1, wherein the insulation layer can be divided into two parts.

7. A turbocharger-catalytic converter assembly comprising:
a turbine casing of the turbocharger which includes a turbine casing flange;
a catalyst flange as part of the catalytic converter; and
a connecting member which fixes the turbine casing flange and the catalyst flange to each other with interposition of a seal, wherein an insulation layer of a thermally resistant elastic material is arranged between the connecting member and the turbine casing flange and the catalyst flange.

8. The turbocharger/catalytic converter assembly according to claim 7, wherein the insulation layer interrupts the metallic contact between the turbine casing flange and the catalyst flange through the connecting member.

9. The turbocharger/catalytic converter assembly according to claim 8, wherein the insulation layer has a pre-shaped form of the flange connection.

10. The turbocharger/catalytic converter assembly according to claim 7, wherein the material of the insulation layer is a high-temperature insulation material.

11. The turbocharger/catalytic converter assembly according to claim 7, wherein the connecting member is configured as a clip.

12. The turbocharger/catalytic converter assembly according to claim 7, wherein the insulation layer can be divided into two parts.
